(19) United States
(12) Patent Application Publication
(10) Pub. No.: US 2026/0208830 A1
(43) Pub. Date: Jul. 23, 2026

(54) Meta-Learning-Based Adaptive Motion Control Method and Apparatus for Underactuated Ship

(71) Applicant: Wuhan University of Technology, Hubei (CN)

(72) Inventors: Shijie Li, Hubei (CN); Cong Li, Hubei (CN); Jialun Liu, Hubei (CN); Jialin Li, Hubei (CN); Yang Li, Hubei (CN); Chengqi Xu, Hubei (CN)

(21) Appl. No.: 19/400,465

(22) Filed: Nov. 25, 2025

(30) Foreign Application Priority Data
Jan. 21, 2025 (CN) 202510091752.1

(51) Int. Cl. B63B 79/20; B63B 79/10; B63B 79/40; G05B 13/02; G05D 1/43; G05D 101/15; G05D 109/30

(52) U.S. Cl. CPC B63B 79/20; B63B 79/10; B63B 79/40; G05B 13/0265; G05D 1/43; G05D 2101/15; G05D 2109/34

(57) ABSTRACT

A meta-learning-based adaptive motion control method and apparatus for an underactuated ship are disclosed. The method includes steps of acquiring ship trajectory data including a set of ship status and control inputs under different environmental conditions and trajectory tracking tasks, constructing a ship trajectory model set according to the ship trajectory data, determining an adaptive control law according to a target state vector, a state vector of a controlled system and a state vector of a reference model, calculating a meta-parameter by meta-learning according to the ship trajectory model set and the adaptive law, and performing adaptive motion control of the underactuated ship according to the meta-parameter.

### CROSS-REFERENCE TO RELATED APPLICATION

This application claims priority to Chinese patent application No. 202510091752.1 filed Jan. 21, 2025, the entire contents of which are incorporated herein by reference.

### TECHNICAL FIELD

The present disclosure relates to the technical field of ship control, and more particularly to a meta-learning-based adaptive motion control method and apparatus for an underactuated ship.

### BACKGROUND

Ships are complex dynamic systems influenced by numerous factors. Conventional ship control methods rely on a precise ship model. However, there are various uncertain disturbance factors such as current, waves, wind direction, wind speed, etc. in the actual operation environment of the ship, such that it is difficult to construct a precise model and determine model parameters. In addition, it is also difficult to make a priori determine for the nonlinear characteristics in the ship system, and the parameter adjustment is complex, so it is likely to lead to overfitting or underfitting, resulting in low precision and low stability of ship motion control. Therefore, the technical problems in the related art need to be solved.

### SUMMARY

Embodiments of the present disclosure provide a meta-learning-based adaptive motion control method and apparatus for an underactuated ship, to effectively improve the precision and stability.

In accordance with one aspect of the present disclosure, an embodiment provides a meta-learning-based adaptive motion control method for an underactuated ship, including:
acquiring ship trajectory data including a set of actual ship states and control inputs;
constructing a data-driven reference ship model set according to the ship trajectory data;
determining an adaptive control law according to the set of actual ship states and the set of output states of the data-driven reference ship model set;
performing adaptive control of the ship along different trajectories by employing different reference models and parameters of the adaptive control law, and collect corresponding trajectory data;
calculating a meta-parameter associated with the data-driven reference ship model set and the adaptive control law; and
performing meta-learning to optimize the meta-parameters.

In some embodiments, constructing a data-driven reference ship reference model set according to the trajectory data includes:
acquiring ship trajectory data including a plurality of actual ship states and corresponding control inputs under different environmental conditions;
performing preprocessing on the acquired trajectory data to remove noise, normalize features, and establish consistent temporal alignment among the data samples;
fitting, under reasonable disturbance assumptions, a parameterized dynamic model for each trajectory using a neural network configured to capture nonlinear relationships between the ship states and control inputs;
training model parameters of each dynamic model via a gradient descent-based optimization method to obtain a plurality of trained dynamic models corresponding to different trajectories or environmental conditions; and
aggregating the plurality of trained dynamic models to form a model ensemble representing the ship's dynamic characteristics across multiple environmental conditions.

In some embodiments, a construction process of the neural network includes:
constructing an input layer configured to receive a current moment state of the ship and a current control input;
constructing a plurality of hidden layers following the input layer, each hidden layer being configured to compute an intermediate ship dynamic representation using a preset nonlinear activation function based on the received inputs; and
constructing an output layer coupled to the hidden layers, the output layer being configured to generate a predicted next ship state according to the processed features.

In some embodiments, determining an adaptive control law includes:
constructing state space equations for the controller system by linearizing the reference models;
receiving a state vector of the controlled system and computing a state vector of a reference model based on their respective control inputs;
calculating a system state error between the actual state vector of the controller system and the state vector of the reference model;
constructing a Lyapunov function according to the state matrix of the reference model and a positive definite matrix;
constructing a real-valued function according to the state error between the reference output from the reference model and the actual output of the controller system, the Lyapunov function value;
differentiating the real-valued function to obtain a derivative equation of the real-valued function;
performing a negative definite transformation on the derivative equation of the real-valued function as a whole to obtain a system of negative definite equations; and
determining the adaptive control law according to the system of negative definite equations and a gain matrix; and
applying the control law to the controlled system.

In some embodiments, calculating a meta-parameter associated with the reference ship model set and an adaptive control law includes:
determining controller parameters based on an adaptive control law and a current state error of a controlled system;
selecting a set of trajectory tracking tasks, and in each trajectory task,
generating a control input according to the current state of the controller system and a reference model output, and a current disturbance condition;
performing real-time adjustment of the parameters of the adaptive control law in each trajectory tracking task based on the state error between the controller system and the reference model;
constraining and optimizing the parameter adjustment process by using a meta-parameter obtained through training across multiple control tasks within a meta-learning framework;
adjusting the parameters of adaptive control law according to the meta-parameter such that the controller achieves rapid adaptation to varying disturbance conditions;
updating the meta-parameter according to an optimization process defined over multiple control tasks to continuously improve overall control adaptability and stability.

In accordance with another aspect of the present disclosure, an embodiment provides a meta-learning-based adaptive motion control apparatus for an underactuated ship, including:
a data collection module configured to acquire ship trajectory data including a set of ship states and corresponding control inputs;
a system dynamic characteristic learning module configured to construct a ship reference model set based on the acquired ship trajectory data under different environmental conditions;
an adaptive controller module configured to determine an adaptive control law according objective states, actual states of the controlled system and the states from a reference model;
a bi-level meta-learning optimization module configured to optimize one or more meta-parameters associated with the adaptive control law and the reference model set; and
a control execution module configured to perform adaptive motion control of the underactuated ship based on the optimized meta-parameters.

In accordance with another aspect of the present disclosure, an embodiment provides a computer device, including: at least one processor; and at least one memory, configured for storing at least one program. The at least one program, when executed by the at least one processor, causes the at least processor to implement the method described above.

The present disclosure has the following beneficial effects.

According to embodiments of the present disclosure, ship trajectory data is first acquired. A reference model set is then constructed based on the acquired trajectory data. An adaptive control law is subsequently determined according to target states, actual states of a controlled system, and states of a reference model. Thereafter, one or more meta-parameters are optimized through meta-learning based on ship trajectory data obtained from multiple trajectory tracking tasks. Finally, adaptive motion control of the underactuated ship is performed according to the optimized meta-parameters. As such, ship motion control is achieved by performing parameter optimization using a meta-learning mechanism, thereby improving control performance and adaptability under complex marine environments.

Additional features and advantages of the disclosure will be set forth in the description which follows, and in part will be obvious from the description, or may be learned by the practice of the disclosure. The objects and other advantages of the present disclosure can be realized and obtained by the structures particularly pointed out in the description and drawings.

### BRIEF DESCRIPTION OF DRAWINGS

To describe the technical schemes of the embodiments of the present disclosure more clearly, the following briefly introduces the accompanying drawings required for describing the embodiments of the present disclosure. Apparently, the accompanying drawings in the following description show only some embodiments of the present disclosure, and those having ordinary skills in the art may still derive other drawings from these accompanying drawings without creative efforts.

FIG. 1 is a flowchart of a meta-learning-based adaptive motion control method for an underactuated ship according to an embodiment of the present disclosure;

FIG. 2 is a flowchart of meta-learning training according to an embodiment of the present disclosure;

FIG. 3 is a schematic structural diagram of a ship motion controller based on model reference adaptive control (MRAC) according to an embodiment of the present disclosure;

FIG. 4 is a schematic diagram of an architecture for ship motion control according to an embodiment of the present disclosure;

FIG. 5 is a schematic structural diagram of a meta-learning-based adaptive motion control apparatus for an underactuated ship according to an embodiment of the present disclosure; and

FIG. 6 is a schematic structural diagram of hardware of a computer device according to an embodiment of the present disclosure.

### DETAILED DESCRIPTION

To make the objectives, technical schemes, and advantages of the present disclosure clearer, the present disclosure is described in further detail with reference to accompanying drawings and embodiments. It is to be understood that the specific embodiments described herein are merely used for explaining the present disclosure, and are not intended to limit the present disclosure. When the following descriptions are made with reference to the accompanying drawings, unless otherwise indicated, the same numbers in different accompanying drawings represent the same or similar elements. Implementations described in the following example embodiments do not represent all implementations consistent with the embodiments of the present disclosure, but are merely examples of apparatuses and methods consistent with some aspects of the embodiments of the present disclosure as detailed in the appended claims.

It can be understood that the terms such as “first,” “second,” and the like used in the present disclosure may be used herein to describe various concepts, but these concepts are not limited by these terms unless otherwise specifically stated. These terms are used only to distinguish one concept from another. For example, without departing from the scope of the embodiments of the present disclosure, first information may also be referred to as second information, and similarly, second information may also be referred to as first information. Depending on the context, the terms “if” or “in a case where” as used herein may be construed as “when . . . ,” or “in response to determining”.

For the terms such as “at least one,” “a plurality of,” “each,” “any,” and the like used in the present disclosure, “at least one” includes one, two, or more than two, “a plurality of” includes two or more, “each” refers to each of a plurality of objects, and “any” refers to any of a plurality of objects.

Unless otherwise defined, meanings of all technical and scientific terms used in this specification are the same as those usually understood by those having ordinary skills in the art to which the present disclosure belongs. Terms used in this specification are merely intended to describe objectives of the embodiments of the present disclosure, but are not intended to limit the present disclosure.

Before the embodiments of the present disclosure are described in detail, a description is made on some nouns and terms in the embodiments of the present disclosure, and the terms in the embodiments of the present disclosure are applicable to the following explanations.

Meta-learning is a learning of an individual's acquisition of learning mechanisms, which involves a problem of how an individual acquires the functions on which he or she relies for learning.

In the related art, classical control algorithms rely on a precise ship model, but as complex dynamic systems, ships are influenced by various factors, such that it is difficult to construct a precise model. In addition, the actual operation environment is complex, and there are various uncertain disturbance factors such as current, waves, wind direction, wind speed, etc., leading to uncertain model parameters and affecting the effect of classical control algorithms. Further, it is extremely difficult to build an accurate model due to sensor noise, actuator delay in the real ship operation and so on. Meanwhile, the effect of classical control algorithm is prone to be interfered by the complex marine environment and the drifted model parameters. Although adaptive control can solve some model uncertainty problems, the application effect of adaptive control is limited because some nonlinear characteristics of underactuated nonlinear systems such as ships are difficult to determine a priori model, and it does not provide an adaptive design for the real ship hardware. Although a data-driven control method does not require a precise model, the parameter adjustment in the algorithm design is complex, which is prone to overfitting or underfitting, and fails to fully consider the nonlinear and underactuated characteristics of the ship system. Further, the data-driven control method does not take in account the cooperative logic of the sensor and actuator of the real ship, so it is difficult to directly apply the simulation model to the real ship.

Although existing data-driven control methods have the advantage of not requiring an accurate physical model, they often involve a large number of parameters that must be tuned during algorithm design. Such parameter tuning increases the complexity of the control process and imposes a significant computational burden. Excessive parameter adjustment may further result in problems such as overfitting or underfitting, thereby degrading the performance and generalization capability of the control model in practical applications.

In addition, in complex ship motion control scenarios, these methods fail to adequately account for the nonlinear and underactuated characteristics of the ship system, and cannot effectively address model uncertainty caused by environmental disturbances. As a result, existing methods are unable to achieve precise and stable motion control, leading to reduced control accuracy and poor robustness under real-world operating conditions.

Meta-learning takes tasks as samples, and realizes the generalization of new tasks by learning transferable feature representations. Through limited training samples and iterations, it can yield a model with strong generalization capability, whose parameters can be quickly adapted to unseen tasks. In the field of ship control, meta-learning can optimize parameters of the controller and reference model based on the actual trajectory tracking data collected from the onboard sensors and actuators, to enable ships to “learn to learn”, simplifying model adaptation in new environments and achieving more flexible and adaptive control, thereby better coping with the problems faced by ship motion control.

In view of this, in the embodiments of the present disclosure, guided by adaptive control, a model is trained on various learning tasks, so that the model can solve new learning tasks using only a small number of training samples. After the model is trained with various tasks, parameters of the model can better fit the nonlinear relationship of the ship system. In different control tasks, the model can quickly adjust its own parameters to meet new task requirements. In addition, this method can effectively cope with the model uncertainty caused by environmental disturbance and ensure that the ship can move according to an expected trajectory in a complex environment, thereby improving the precision and stability of ship motion control, and avoiding a “disconnection” between simulation and real ship in ship motion control. A ship motion control architecture mainly includes a system dynamic characteristic learning module, an adaptive controller module, and a bi-level meta-learning optimization module.

In the system dynamic characteristic learning module, dynamic characteristic information of the ship in different environments is acquired by analyzing and processing ship trajectory data. This module first preprocesses collected trajectory data including a ship status and control input information, fits a model with parameters to each trajectory under a reasonable disturbance assumption, trains model parameters using a method such as gradient descent, and finally combines a plurality of trained models into a model ensemble, constructs a meta-problem based on the model ensemble, and learns a meta-parameter related to system dynamics.

In the adaptive controller module, a suitable adaptive controller structure is designed based on the dynamic characteristics of the ship and a control objective. On the basis of considering the ship as a dynamic system, this module is configured to determine a specific form of adaptive controller according to its nonlinear dynamic equations. When some information such as external force is unknown, the information may be approximated using a neural network or other methods.

The bi-level meta-learning optimization module bridges and optimize between the system dynamic characteristic learning module and the adaptive controller module. It establishes a plurality of loss functions, training datasets, and evaluation datasets corresponding to a plurality of tasks, and defines an task-specified meta-learning mechanism to map the reference model set and adaptive control law to one or more meta-parameters based on task-specific training data, to solve the bi-level problem to find optimal meta-parameters. During this process, meta-learning is performed based on the training data sets, in which the task loss function is defined according to the control performance in each trajectory tracking task.

The meta-learning-based adaptive motion control method for an underactuated ship according to the embodiments of the present disclosure relates to the technical field of ship control. The meta-learning-based adaptive motion control method for an underactuated ship according to the embodiments of the present disclosure may be applied to a terminal or a server, or may be software running in a terminal or a server. In some embodiments, the terminal may be a smartphone, a tablet computer, a notebook computer, a desktop computer, a smart speaker, a smartwatch, an in-vehicle terminal, and the like, but is not limited thereto. The server may be configured as an independent physical server, or may be configured as a server cluster or distributed system including a plurality of physical servers, or may be configured as a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The server may also be a node server in a blockchain network. The software may be an application for implementing the meta-learning-based adaptive motion control method for an underactuated ship, etc. However, the present disclosure is not limited to the above forms.

The present disclosure may be used in a wide variety of general purpose or special purpose computer system environments or configurations, for example, personal computers (PCs), server computers, handheld or portable devices, tablet-type devices, multiprocessor systems, microprocessor-based systems, set-top boxes, programmable consumer electronic devices, network PCs, midrange computers, mainframe computers, distributed computing environments including any of the above systems or devices, etc. The present disclosure may be described in the general context of computer-executable instructions executed by a computer, for example, program modules. Generally, the program modules include routines, programs, objects, components, data structures, and the like for performed specific tasks or implementing specific abstract data types. The present disclosure may also be practiced in distributed computing environments in which tasks are performed by remote processing devices connected through a communication network. In a distributed computing environment, program modules may be located in local and remote computer storage media, including storage devices.

The embodiments of the present disclosure will be described in detail below with reference to the accompanying drawings.

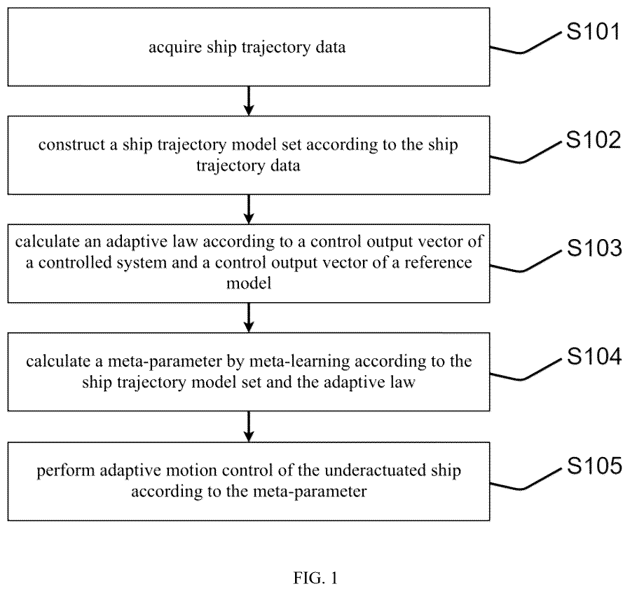

FIG. 1 is an optional flowchart of a meta-learning-based adaptive motion control method for an underactuated ship according to an embodiment of the present disclosure. The method in FIG. 1 may include, but is not limited to, following steps S101 to S105.

At the step S101, ship trajectory data including a set of ship states and control inputs are acquired, under different trajectory tracking tasks and environmental conditions.

At the step S102, a ship trajectory model set is constructed according to the ship trajectory data.

At the step S103, an adaptive law is calculated according to a target state, the current state of a controlled system and the current state of a reference model.

At the step S104, a meta-parameter is calculated after meta-learning according to the ship trajectory model set and the adaptive law.

At the step S105, adaptive motion control of the underactuated ship is performed according to the meta-parameter.

Through the steps S101 to S105 illustrated in the embodiments of the present disclosure, ship motion control is achieved, thereby improving the precision and stability.

In some embodiments, in the step S101, the ship trajectory data may be acquired from sea trials, high fidelity simulation platform, or physical experiments. For example, under different sea conditions, ship state information data in different trajectory tracking tasks of the ship is collected by high-precision differential GPS, inertial navigation and other navigation equipment. The ship trajectory data includes a set of ship states and current control inputs. For example, trajectory control may be performed in a simulation platform or on an actual ship in open water, respectively under a moderate Sea State 1 condition, a Sea State 3 condition, and a Sea State 5 condition, to collect a plurality of sets of ship trajectory data. Under the Sea State 1 condition, 100 sets of ship trajectory data are collected, and each set of ship trajectory data contains 500 sampling points. Under the Sea State 3 condition, 200 sets of ship trajectory data are collected, and each set of ship trajectory data contains 1000 sampling points. Under the Sea State 5 condition, 300 sets of ship trajectory data are collected, and each set of ship trajectory data contains 1500 sampling points. It can be understood that the number of samples may be set according to different working conditions. Under the Sea State 1 condition, the motion pattern of the ship is moderate, and 500 sampling points are sufficient to meet modeling requirements. Under the Sea State 3 condition, the environment is relatively mild, the motion of the ship is relatively stable, but a large number of pieces of data are needed to reflect the motion characteristics of the ship. Under the Sea State 5 condition, the sea conditions are harsh, and the changes of ship motion are more complicated, so it is required more data and longer sampling to comprehensively reflect the motion characteristics of the ship under this sea condition as compared with the other working conditions. Further, in the process of ship motion, a ship status and a control input are sampled under the above three working conditions periodically. Information of the ship status may include a location (longitude, latitude), speed, or heading of the ship, etc. Information of the control input may include a rudder angle or a propeller speed. A large number of pieces of original sampled ship trajectory data are organized and preprocessed to obtain trajectory data

$${\{ {T}_{j} \}}_{j = 1}^{M}$$

of the ship in different time periods, and each trajectory is

$${T}_{j} = {\{ {t}_{k}^{( j )} , {x}_{k}^{( j )} , {u}_{k}^{( j )} , {t}_{k + 1}^{( j )} , {x}_{k + 1}^{( j )} \}}_{k = 0}^{{N}_{j - 1}} ,$$

where M represents the total number of sets of ship trajectory data, j ranges from 1 to M,

$${t}_{k}^{( j )}$$

represents a time value corresponding to a k^{th} sampling moment in a j^{th} time period,

$${x}_{k}^{( j )}$$

represents status information of the ship at the k^{th} sampling moment in the j^{th} time period

$${u}_{k}^{( j )}$$

represents a control input at the k^{th} sampling moment in the j^{th} time period, and N represents the number of sampling points collected in each set.

In some embodiments, constructing a ship trajectory model set according to the ship trajectory data in the step S102 may include, but is not limited to, the following steps:
acquiring ship trajectory data including a plurality of ship states and corresponding control inputs under different environmental conditions;
performing preprocessing on the acquired trajectory data to remove noise, normalize features, and establish consistent temporal alignment among the data samples;
fitting, under reasonable disturbance assumptions, a parameterized dynamic model for each trajectory using a neural network configured to capture nonlinear relationships between the ship states and control inputs;
training model parameters of each dynamic model via a gradient descent-based optimization method to obtain a plurality of trained dynamic models corresponding to different trajectories or environmental conditions; and
aggregating the plurality of trained dynamic models to form a model ensemble representing the ship's dynamic characteristics across multiple environmental conditions.

In some embodiments, at first, dynamic characteristic fitting may be performed for each trajectory τⱼ using a preset neural network according to a ship status x and an initial control input u to obtain an initial ship trajectory model. It can be understood that data of each trajectory is fitted, so that a model f̅ⱼ(x, u, φⱼ) can describe ship dynamic characteristics corresponding to the trajectory as accurately as possible, where φⱼ represents a model parameter. Different trajectories have different model parameters, which reflect the differences between ship dynamics in different tasks and environments. Then, a ship status prediction value is calculated according to the ship status, the initial control input, the model parameter, and the dynamic relationship function. The ship status prediction value is calculated using the following formula:

$${\hat{x}}_{k + 1}^{( j )} = {x}_{k}^{( j )} + {\int }_{{t}_{k}^{( j )}}^{{t}_{k + 1}^{( j )}} \hat{{f}_{j}} ( x ( t ) , {u}_{k}^{( j )} , {φ}_{j} ) d t ,$$

where

$${\hat{x}}_{k + 1}^{( j )}$$

represents a ship status prediction value predicted where by the model for a ship status at a (k+1)^{th} sampling moment in the j^{th} time period,

$${x}_{k}^{( j )}$$

represents actual status information of the ship at a k^{th} sampling moment in the j^{th} time period, x(t) represents the ship status,

$${u}_{k}^{( j )}$$

represents the initial control input, φⱼ represents a model parameter corresponding to a j^{th} trajectory, and \hat{f}ⱼ represents the dynamic relationship function, i.e., a function expression related to a fitting model corresponding to the j^{th} trajectory, which describes the dynamic relationship of the ship status changing with time. Then, an objective function is constructed according to the ship status prediction value, the regularization coefficient, the meta-parameter, and a number of sampling moments. The objective function may be

$${min}_{{φ}_{j}} \frac{1}{{N}_{j}} ( {\sum }_{k = 0}^{{N}_{j} - 1} {‖ {x}_{k + 1}^{( j )} - {\hat{x}}_{k + 1}^{( j )} ‖}_{2}^{2} + μ {‖ θ ‖}_{2}^{2} ) ,$$

where Nⱼ represents the number of sampling moments in the j^{th} trajectory,

$${x}_{k + 1}^{( j )}$$

represents actual status information of the ship at the (k+1)^{th} sampling moment in the j^{th} time period, μ represents the regularization coefficient, and θ represents the meta-parameter.

Finally, model parameter training is performed using stochastic gradient descent according to the objective function, depending on the working condition, a plurality of target ship trajectory models, and the plurality of target ship trajectory models are combined to obtain the ship trajectory model set. For example, during the training process, Adagrad, a variant of a stochastic gradient descent algorithm, may be employed for optimization. All the target ship trajectory models obtained by fitting are formed into the ship trajectory model set. It can be understood that the ship trajectory model set is a set of a plurality of models, which is used in subsequent meta-learning and control decision-making processes. To improve the accuracy and generalization capability of the model ensemble, different weights are assigned to each target ship trajectory model according to different environmental condition. A model with higher similarity with the actual environmental condition is assigned a larger weight, and a model with lower simlarity is assigned a smaller weight, so that the ship trajectory model set as a whole can better reflect the dynamic characteristics of the ship, thereby improving its adaptability to different tasks and environments.

In some embodiments, a construction process of the preset neural network includes:
constructing an input layer configured to receive a current moment state of the ship and the current control input;
constructing two hidden layers after the input layer, where the two hidden layers are configured to calculate a next moment state of the ship using a preset nonlinear activation function according to the current moment state and the current control input; and
constructing an output layer after the two hidden layers.

In some embodiments, one input layer, two hidden layers, and one output layer may be constructed in sequence. The input layer is configured to receive the current moment state of the ship and the current control input. The two hidden layer are configured to calculate the next moment state of the ship using a preset nonlinear activation function according to the current moment state and the current control input. The output layer is configured to output the predicted next moment state of the ship.

In some embodiments, at first, the state vector of the controlled system may be calculated according to the control output vector of the controlled system. The state vector of the controlled system is calculated using the following formula: Xₛ=Yₛ, where Xₛ represents the state vector of the controlled system, and Yₛ represents the control output vector of the controlled system. Then, a control law is calculated according to the state vector of the controlled system, the control input of the reference model, the initial feedforward controller, and the initial state feedback controller. The control law is calculated using the following formula: Uₛ=FXₛ+KUₘ, wherein Uₛ represents the control law, F represents the initial state feedback controller, K represents the initial feedforward controller, and Uₘ represents the control input of the reference model. The control law is determined as a control input of the controlled system. A system of state space equations is constructed according to the state vector of the controlled system, the control input of the controlled system, the state matrix of the controlled system, and the input matrix of the controlled system. The system of state space equations may be

$$\{ \begin{matrix}{\dot{X}}_{s} = {A}_{s} {X}_{s} + {B}_{s} {U}_{s} \\ {X}_{s} = {Y}_{s}\end{matrix} ,$$

where \dot{X}ₛ represents a derivative of the state vector of the controlled system, Aₛ represents the state matrix of the controlled system, and Bₛ represents the input matrix of the controlled system. The state vector of the reference model is calculated according to the control output vector of the reference model. The state vector of the reference model is calculated using the following formula: Xₘ=Yₘ, where Xₘ represents the state vector of the reference model, and Yₘ represents the control output vector of the reference model. The reference model is constructed according to the state vector of the reference model, the control input of the reference model, the state matrix of the reference model, and the input matrix of the reference model. The reference model may

$$be \{ \begin{matrix}{\dot{X}}_{m} = {A}_{m} {X}_{m} + {B}_{m} {U}_{m} \\ {X}_{m} = {Y}_{m}\end{matrix} ,$$

where \dot{X}ₘ represents a derivative of the state vector of the reference model, Aₘ represents the state matrix of the reference model, Bₘ represents the input matrix of the reference model and Uₘ represents the control input of the reference model. The error between the reference output and the actual output is calculated according to the state vector of the controlled system and the state vector of the reference model. The error between the reference output and the actual output is calculated using the following formula: eₓ=Xₘ−Xₛ, where eₓ represents the error between the reference output and the actual output. The system state error is calculated according to the error between the reference output and the actual output, the system of state space equations, and the reference model. The system state error is calculated using the following formula:

$$\begin{matrix}{\dot{e}}_{x} = {\dot{X}}_{m} - {\dot{X}}_{s} \\ = {A}_{m} {X}_{m} + {B}_{m} {U}_{m} - ( {A}_{s} + {B}_{s} F ) {X}_{s} - {B}_{s} K {U}_{m} \\ = {A}_{m} ( {X}_{m} - {X}_{s} ) + ( {A}_{m} - {A}_{s} - {B}_{s} F ) {X}_{s} + ( {B}_{m} - {B}_{s} K ) {U}_{m} \\ = {A}_{m} {e}_{x} + ( {A}_{m} - {A}_{s} - {B}_{s} F ) {X}_{s} + ( {B}_{m} - {B}_{s} K ) {U}_{m}\end{matrix}$$

Then, the system state error is updated according to a system state convergence equation. Finally, the adaptive law is calculated according to the system state error.

In some embodiments, updating the system state error according to a system state convergence equation includes:
constructing a target feedforward controller according to the initial feedforward controller, the system state convergence equation, and the error between the reference output and the actual output;
constructing a target state feedback controller according to the initial state feedback controller, the system state convergence equation, and the error between the reference output and the actual output;
constructing a system of matching equations in which the reference model matches the controlled system according to the target feedforward controller and the target state feedback controller;
calculating a feedforward controller difference according to the initial feedforward controller and the target feedforward controller;
calculating a state feedback controller difference according to the initial state feedback controller and the target state feedback controller; and
updating the system state error according to the system of matching equations, the feedforward controller difference, and the state feedback controller difference.

In some embodiments, the target feedforward controller may be constructed according to the initial feedforward controller, the system state convergence equation, and the error between the reference output and the actual output. The target feedforward controller may be K(eₓ, t)=K₀, where K represents the target feedforward controller, K₀ represents the initial feedforward controller, eₓ represents the error between the reference output and the actual output, and t represents time. The target state feedback controller is constructed according to the initial state feedback controller, the system state convergence equation, and the error between the reference output and the actual output. The target state feedback controller may be F(eₓ, t)=F₀, where F represents the target state feedback controller, and F₀ represents the initial state feedback controller. The system of matching equations in which the reference model matches the controlled system is constructed according to the target feedforward controller and the target state feedback controller. The system of matching equations may be

$$\{ \begin{matrix}{A}_{s} + {B}_{s} {F}_{0} = {A}_{m} \\ {B}_{s} {K}_{0} = {B}_{m}\end{matrix} ,$$

where Aₛ represents the state matrix of the controlled system, Bₛ represents the input matrix of the controlled system, Aₘ represents the state matrix of the reference model, and Bₘ represents the input matrix of the reference model. The feedforward controller difference is calculated according to the initial feedforward controller and the target feedforward controller. The feedforward controller difference is calculated using the following formula: \tilde{K}=K₀−K, where \tilde{K} represents the feedforward controller difference. The state feedback controller difference is calculated according to the initial state feedback controller and the target state feedback controller. The state feedback controller difference is calculated using the following formula: \tilde{F}=F₀−F, where \tilde{F} represents the state feedback controller difference. Finally, the system state error is updated according to the system of matching equations, the feedforward controller difference, and the state feedback controller difference. The updated system state error may be

$${\dot{e}}_{x} = {A}_{m} {e}_{x} + {B}_{m} {K}_{0}^{- 1} \tilde{F} {X}_{s} + {B}_{m} {K}_{0}^{- 1} \tilde{K} {U}_{m} ,$$

in which Aₛ and Bₛ are eliminated. It can be understood that in order to achieve system state convergence,

$${lim}_{t \to ∞} e ( t ) = 0 ,$$

where t represents time, e(t) represents a function of the error changing with time. When time approaches infinity, the error approaches 0, indicating that the system is stable.

In some embodiments, determining the adaptive law may include:
constructing state space equations for the controller system by linearizing the reference models;
receiving a state vector of the controlled system and computing a state vector of a reference model based on their respective control inputs;
calculating a system state error between the actual state vector of the controller system and the state vector of the reference model;
constructing a Lyapunov function according to the state matrix of the reference model and a positive definite matrix;
constructing a real-valued function according to the state error between the reference output from the reference model and the actual output of the controller system, the Lyapunov function value;
differentiating the real-valued function to obtain a derivative equation of the real-valued function;
performing a negative definite transformation on the derivative equation of the real-valued function as a whole to obtain a system of negative definite equations; and
determining the adaptive control law according to the system of negative definite equations and a gain matrix; and
applying the control law to the controlled system.

In some embodiments, at first, a Lyapunov function may be constructed according to the state matrix of the reference model and the positive definite matrix. The Lyapunov function may be

$${A}_{m}^{T} + P {A}_{m} + Q = 0 ,$$

where Aₘ represents the state matrix of the reference model, Q represents the positive definite matrix, and P represents a Lyapunov function value. Then, the Lyapunov function is solved to obtain the Lyapunov function value P. The real-valued function is constructed according to the error between the reference output and the actual output, the Lyapunov function value, the feedforward controller difference, and the state feedback controller difference. The real-valued function may be

$$V = {e}_{x}^{T} P {e}_{x} + t r ( {F}^{T} {P}_{F}^{- 1} \tilde{F} ) + tr ( \tilde{K} {P}_{K}^{- 1} \tilde{K} ) ,$$

where eₓ represents the error between the reference output and the actual output, F represents the target state feedback controller, \tilde{K} represents the feedforward controller difference, \tilde{F} represents the state feedback controller difference, P_{F} represents a Lyapunov function value of the target state feedback controller, and P_{K} represents a Lyapunov function value of the target feedforward controller. The real-valued function is differentiated to obtain the derivative equation of the real-valued function. The derivative equation of the real-valued function may be

$$\dot{V} = {\dot{e}}_{x}^{T} {Pe}_{x} + {e}_{x}^{T} P {\dot{e}}_{x} + tr ( {\dot{\tilde{F}}}^{T} {P}_{F}^{- 1} \tilde{F} + {\tilde{F}}^{T} {P}_{F} \dot{\tilde{F}} ) + tr ( {\dot{\tilde{K}}}^{T} {P}_{K}^{- 1} \tilde{K} + {\tilde{K}}^{T} {P}_{K}^{- 1} \dot{\tilde{K}} ) = {\dot{e}}_{x}^{T} ( {A}_{m}^{T} P + P {A}_{m} ) {e}_{x} + 2 tr ( {\dot{\tilde{F}}}^{T} {P}_{F}^{- 1} \tilde{F} + {X}_{s} {e}_{x}^{T} P {B}_{m} {K}_{0}^{- 1} \tilde{F} ) + 2 tr ( {\dot{\tilde{K}}}^{T} {P}_{K}^{- 1} \tilde{K} + {U}_{m} {e}_{x}^{T} P {B}_{m} {K}_{0}^{- 1} \tilde{K} ) ,$$

where Bₘ represents the input matrix of the reference model, Uₘ represents the control input of the reference model, tr represents the trace of the matrix, \tilde{\dot{F}} represents a derivative of \tilde{F}, \tilde{\dot{K}} represents a derivative of \tilde{K},

$${e}_{x}^{T}$$

represents a transpose of eₓ, ėₓ represents a derivative of eₓ,

$${K}_{0}^{- 1}$$

represents an inverse matrix of K₀,

$${P}_{K}^{- 1}$$

represents an inverse matrix of P_{K}, and \tilde{\dot{K}}^{T} represents a transpose of \tilde{\dot{K}}.

Then, a negative definite transformation is performed on the derivative equation of the real-valued function as a whole to obtain a system of negative definite equations. The system of matching equations may be

$$\{ \begin{matrix}\dot{F} = {P}_{F} {K}_{0}^{- T} {B}_{m}^{T} P {e}_{x} {X}_{s}^{T} \\ \dot{K} = {P}_{K} {K}_{0}^{- T} {B}_{m}^{T} P {e}_{x} {U}_{m}^{T}\end{matrix} ,$$

where \dot{F} represents a derivative of F, \dot{K} represents a derivative of K,

$${K}_{0}^{- T}$$

represents a negative transpose of K₀,

$${B}_{m}^{T}$$

represents a transpose of Bₘ, and

$${X}_{s}^{T}$$

represents a transpose of Xₛ, and

$${U}_{m}^{T}$$

represents a transpose of Uₘ. Finally, the adaptive law is constructed according to the system of negative definite equations and the gain matrix. The adaptive law may be

$$\{ \begin{matrix}\dot{F} = {γ}_{1} {B}_{m}^{T} P {e}_{x} {X}_{s}^{T} \\ \dot{K} = {γ}_{2} {B}_{m}^{T} P {e}_{x} {U}_{m}^{T}\end{matrix} ,$$

where γ₁ and γ₂ are both gain matrices. It can be understood that the adaptive law followed by the parameters K and F provides a basic control logic for subsequent meta-learning optimization. The calculated adaptive law focuses on real-time adjustment of controller parameters according to information such as the system state error in a single control period to ensure that the system stably tracks a reference trajectory. The subsequent bi-level meta-learning optimization uses a large number of different tasks to train the controller parameters, including optimal settings of parameters such as K and F under different tasks, from multiple tasks and the overall meta-learning framework. Therefore, the adaptive law and the bi-level meta-learning optimization form a synergistic effect.

In some embodiments, calculating a meta-parameter associated with the data-driven reference ship model set and the adaptive control law in the step S104 may include, but is not limited to, following steps:
determining controller parameters based on an adaptive control law and a current state error of a controlled system;
selecting a set of trajectory tracking tasks, and in each trajectory task;
generating a control input according to the current state of the controller system and a reference model output, and a current disturbance condition;
performing real-time adjustment of the parameters of the adaptive control law in each trajectory tracking task based on the state error between the controller system and the reference model;
constraining and optimizing the parameter adjustment process by using a meta-parameter obtained through training across multiple control tasks within a meta-learning framework;
adjusting the parameters of adaptive control law according to the meta-parameter such that the controller achieves rapid adaptation to varying disturbance conditions;
updating the meta-parameter according to an optimization process defined over multiple control tasks to continuously improve overall control adaptability and stability.

In some embodiments, a meta-learning framework is built to define a plurality of ship tasks each of which corresponds to one reference trajectory and one disturbance signal. The meta-problem is constructed by combining elements of all the ship tasks. A parameter of an adaptive controller is obtained by solving the meta-problem through gradient descent. The elements mainly include reference trajectory, disturbance signal, status information of the ship, control input information, and a parameter related to the adaptive controller. Firstly, the plurality of ship tasks may be set according to the ship trajectory model set, and the corresponding disturbance signal may be set for each ship task. For example, during the process of collecting trajectory data Tⱼ, considering the complexity of an actual situation and in order to simplify the model learning process, it is assumed that disturbance w(t) is a fixed unknown value wⱼ. In addition, a reference trajectory rᵢ(t) and a disturbance signal wⱼ(t) may be used as a training set

$${D}_{i j}^{train} = {\{ {r}_{i} ( t ) , {w}_{j} ( t ) \}}_{t ∈ [ o , T ]}$$

for a ship task (i, j) in a time range T, where the ship task (i, j) represents a task set composed of an i^{th} reference trajectory and a j^{th} disturbance signal. Then, the meta-parameter is constructed according to the adaptive law, the parameter related to the x control input function, and the parameter related to the density control input function to achieve a good tracking effect for the reference trajectory under a given disturbance. The meta-parameter may be θ=(θ_{π},θₚ), where θ represents the meta-parameter, θ_{π} represents the parameter related to the x control input function, which is related to a control input function π, θ_{ρ} represents the parameter related to the density control input function, which is related to a control input function ρ. It can be understood that the meta-parameter θ is a generalized set of adaptive controller parameters configured to learn a parameter that enables the controller to have a good tracking effect for the reference trajectory under a given disturbance under the meta-learning framework, and it is an extension and optimization of the feedforward controller K and the state feedback controller F at the meta-learning level. Through the optimization in the embodiments of the present disclosure, the parameter in the adaptive law can obtain better initial values and be adaptively adjusted according to more task scenarios, thereby improving the precision, generalization capability, and adaptability of the entire ship motion control for different environments and different tasks.

Then, target ship status information is determined according to initial ship status information and the adaptive input function. The target ship status information is determined using the following formula:

$${x}_{i j} ( t ) = {x}_{i j} ( 0 ) + {\int }_{0}^{T} f ( {x}_{ij} ( t ) , {u}_{i j} ( t ) , {w}_{j} ( t ) ) d t ,$$

where xᵢⱼ(t) represents the target ship status information, xᵢⱼ(0) represents the initial ship status information, f represents the adaptive input function, xᵢⱼ(t) represents status information of the ship at a moment t under the ship task (i, j), and wⱼ(t) represents the disturbance signal. The target adaptive mechanism-related quantity is calculated according to the meta-parameter, the initial adaptive mechanism-related quantity, the density control input function, and the disturbance signal. The target adaptive mechanism-related quantity is calculated using the following formula:

$${a}_{i j} ( t ) = {a}_{i j} ( 0 ) + {\int }_{0}^{T} ρ ( {x}_{i j} ( t ) , {u}_{i j} ( t ) , {w}_{j} ( t ) ; {θ}_{ρ} ) dt ,$$

where aᵢⱼ(t) represents the target adaptive mechanism-related quantity, aᵢⱼ(0) represents the initial adaptive mechanism-related quantity, and ρ represents the density control input function. Control input information is determined according to the meta-parameter, the reference trajectory, and the x control input function. The control input information is determined using the following formula: uᵢⱼ(t)=π(xᵢⱼ(t), rᵢ(t), aᵢⱼ(t); θₙ), where uᵢⱼ(t) represents the control input information, rᵢ(t) represents the reference trajectory, and It represents the x control input function. A key information set is calculated according to the target ship status information, the target adaptive mechanism-related quantity, and the control input information. The key information set is calculated using the following formula: φᵢⱼ={xᵢⱼ(t), aᵢⱼ(t), uᵢⱼ(t)}_{t∈[o,T]}, where φᵢⱼ represents the key information set, and T represents the total time.

Then, the average tracking error is calculated according to the reference trajectory and the disturbance signal. The average tracking error may be Dᵢⱼ={rᵢ(t), wⱼ(t)}_{t∈[0,T]}, where Dᵢⱼ represents the average tracking error. The loss function is constructed according to the key information set, the average tracking error, and the control gain adjustment parameter. The loss function may be

$${L}_{i j} ( {φ}_{ij} , {D}_{i j} ) = \frac{1}{T} {\int }_{0}^{T} ( {‖ {x}_{i j} ( t ) - {r}_{i} ( t ) ‖}_{2}^{2} + α {‖ {u}_{i j} ( t ) ‖}_{2}^{2} ) d t ,$$

where Lᵢⱼ represents the loss function, a represents the control gain adjustment parameter, and α≥0. It can be understood that the loss function is obtained through comprehensive calculation based on the control input information and a deviation between the actual ship state and the reference trajectory. A smaller value of the loss function indicates a better control effect, i.e., the ship can better track the reference trajectory. The meta-problem is constructed according to the meta-parameter, the actual ship state, the reference trajectory, the control gain adjustment parameter, the initial control input information, the regularization parameter, the number of reference trajectories, and the number of disturbance signals. The meta-problem may be

$${min}_{θ} \frac{1}{NMT} ( {\sum }_{i = 1}^{N} {\sum }_{j = 1}^{M} {\int }_{0}^{T} {c}_{i j} ( t ) d t + {μ}_{meta} {‖ θ ‖}_{2}^{2} ) , where$$

$${c}_{i j} = {‖ {x}_{i j} - {r}_{i} ‖}_{2}^{2} + α {‖ {u}_{i j} ‖}_{2}^{2} ,$$

μₘₑₜₐ represents the regularization parameter, N represents the number of reference trajectories, and M represents the number of disturbance signals. The meta-problem is solved using adaptive gradient descent according to the loss function to update the meta-parameter. It can be understood that in the meta-problem, N reference trajectories are constructed, and M disturbance signals

$${\{ {w}_{j} ( t ) \}}_{j = 1}^{M}$$

are sampled.

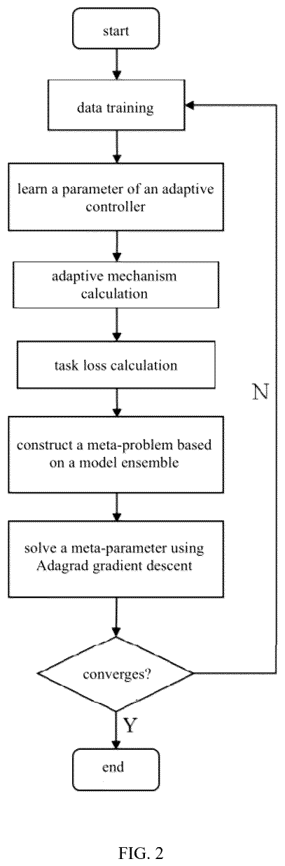

In some embodiments, referring to FIG. 2, which is a flowchart of meta-learning training, data training is performed firstly to learn the parameter of the adaptive controller. Then, adaptive mechanism calculation and task loss calculation are performed. Then, the meta-problem is constructed based on the model ensemble, and the meta-parameter is determined using Adagrad gradient descent. Finally, it is determined whether the meta-parameter converges. If the meta-parameter converges, it indicates that the meta-learning training is finished.

In some embodiments, at first, a plurality of values of the diagonal matrix and the meta-parameter may be initialized. For example, the meta-parameter θ may be initialized to a random value or to an initial value set according to prior knowledge. At the same time, a diagonal matrix H=0 with the same dimensions as the meta-parameter θ is initialized, the diagonal matrix is configured to record a sum of squares of historical gradients of each parameter. Then, a gradient of the objective function with respect to the meta-parameter is calculated according to the ship task. For example, a ship task (i, j) may be randomly selected, which is composed of the reference trajectory rᵢ(t) and the disturbance signal wⱼ(t), and a gradient hᵢⱼ(θ) of the objective function with respect to the meta-parameter θ under the current task is calculated. Then, the diagonal matrix is updated according to the gradient of the objective function with respect to the meta-parameter. For example, a diagonal matrix may be updated by H=H+hᵢⱼ(θ)², i.e., the square of the current gradient is accumulated to corresponding angular element of H to record a sum of squares of historical gradients of each parameter. The adaptive learning rate is calculated according to the auxiliary positive number, the global learning rate, and the updated diagonal matrix. The adaptive learning rate is calculated using the following formula:

$${η}_{i j} = \frac{η}{\sqrt{H + ξ}} ,$$

where nᵢⱼ represents the adaptive learning rate, η represents an initially set global learning rate, H represents the updated diagonal matrix, and ξ represents the auxiliary positive number, which is a small positive number used to prevent the denominator from being zero. Finally, the meta-parameter is updated according to the adaptive learning rate and the loss function, until the change in the meta-parameter is less than the preset change threshold. For example, the algorithm is considered to converge when the value of the objective function of the meta-problem no longer drops significantly and the change of the meta-parameter θ is less than the preset change threshold, i.e., for all meta-parameter θᵢ,

$$\vert {θ}_{i}^{k} - {θ}_{i}^{k - 1} \vert < {δ}_{i}$$

is satisfied after T consecutive iterations, where

$${θ}_{i}^{k}$$

represents a value of an i^{th} meta-parameter in a k^{th} iteration, and δᵢ represents a threshold corresponding to the i^{th} meta-parameter. It can be understood that during the process of solving the meta-problem, a series of operations using the Adagrad gradient descent algorithm, including initialization, gradient calculation, correlation matrix update, learning rate determination, meta-parameter update, etc. are all performed for the objective function of the meta-problem. The purpose is to minimize the value of the objective function through continuous iterative optimization, to find an optimal meta-parameter, thus solving the meta-problem.

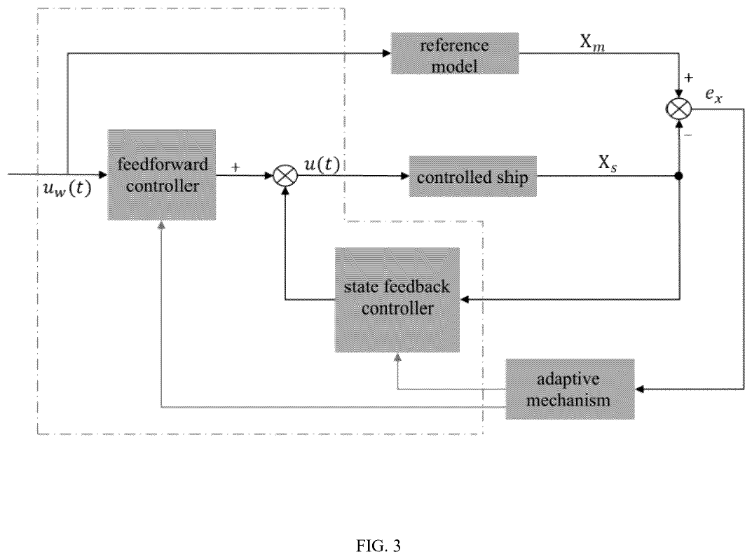

In some embodiments, in the step S105, adaptive motion control of the underactuated ship may be performed according to the meta-parameter. For example, FIG. 3 shows a ship motion controller based on model reference adaptive control (MRAC). In the process of ship motion control, based on the updated parameters of the target state feedback controller F and the target feedforward controller K, an MRAC controller calculates a control input Uₛ of the reference model according to a current actual ship state Xₛ, a control output Uₘ of the reference model, and a current disturbance status. In addition, in each control period, the MRAC controller adjusts K and F in real time according to the system state error and the parameter adaptive law. The adjustment process is restricted and optimized by the meta-parameter θ. According to a training result of multiple tasks under the entire meta-learning framework, the meta-parameter θ guides F and K to adjust in a direction which is conducive for the ship to track a trajectory in a complex environment. For example, when the ship encounters a new type of disturbance, the meta-parameter θ causes F and K of the MRAC controller to quickly adapt to this change, so that the control input Uₛ of the reference model can correct the heading and speed of the ship in time to ensure that the actual trajectory of the ship closely follows the reference trajectory, thereby realizing adaptive motion control of the underactuated ship.

The embodiments of the present disclosure have the following beneficial effects. According to the embodiments of the present disclosure, at first, ship trajectory data is acquired to construct the ship trajectory model set according to the ship trajectory data. Then, the adaptive law is determined according to the control output vector of the controlled system and the control output vector of the reference model. Afterward, the meta-parameter is calculated after meta-learning according to the ship trajectory model set and the adaptive law. Finally, adaptive motion control of the underactuated ship is performed according to the meta-parameter. As such, ship motion control is achieved through parameter calculation based on meta-learning, thereby improving the precision and stability.

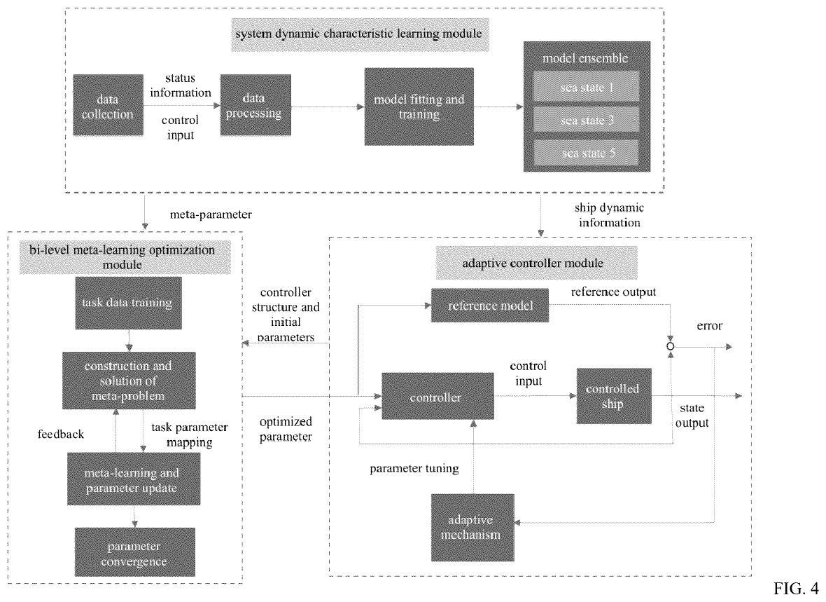

In some embodiments, according to an architecture for ship motion control in FIG. 4, data is collected at first. Then, data processing, model fitting and training, and model ensemble are performed by the system dynamic characteristic learning module. The reference model, the controller, and the adaptive mechanism are constructed by the adaptive controller module. Task data training, construction and solution of a meta-problem, and meta-learning and parameter update, are performed by the bi-level meta-learning optimization module, until a parameter converges. Finally, the controlled ship is controlled by the control module. In this embodiment, the system dynamic characteristic learning module is configured to analyze the ship trajectory data to perform a model ensemble, and the bi-level element learning optimization module is configured to train and optimize the parameters of the adaptive controller and the model, so that the precision of ship motion control is improved. In this embodiment, the adaptive controller module is designed based on ship dynamics, and the model parameters are reasonable values obtained through the cooperation of the system dynamic characteristic learning module and the bi-level element learning optimization module, so that higher interpretability is achieved. In this embodiment, through the use of the meta-learning method, a adaptive controller with a generalization capability can be obtained through training with only a few samples and iterations, and the parameters can be quickly adjusted for different tasks to adapt to new requirements, so that the generalization capability and learning efficiency of the adaptive law are improved. In this embodiment, the model parameters can be quickly adjusted to adapt to different control tasks and environmental changes through the cooperation of the various modules, so that the adaptability to environments is improved.

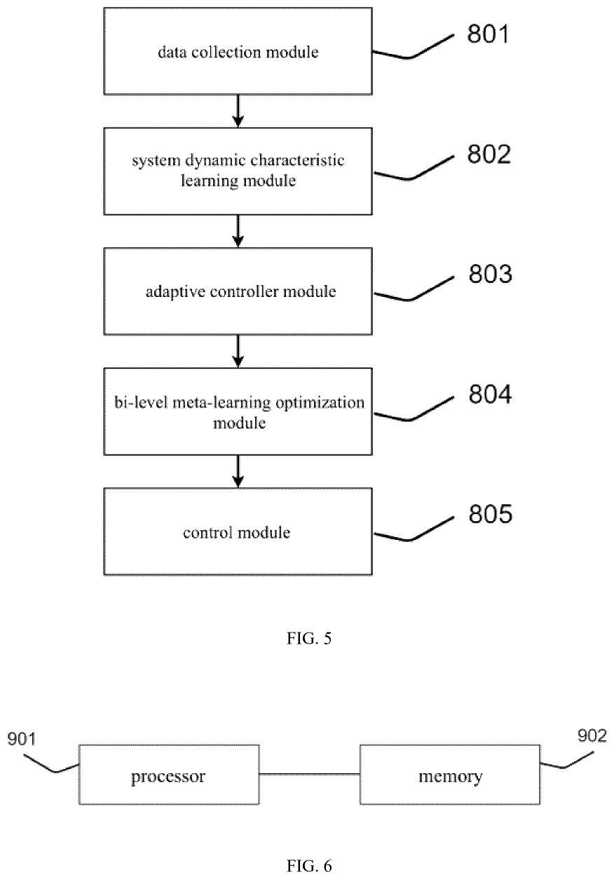

As shown in FIG. 5, an embodiment of the present disclosure further provides a meta-learning-based adaptive motion control apparatus for an underactuated ship, including:
a data collection module 801 configured to acquire ship trajectory data including a ship status and an initial control input;
a system dynamic characteristic learning module 802 configured to construct a ship trajectory model set according to the ship trajectory data;
an adaptive controller module 803 configured to determine an adaptive law according to a control output vector of a controlled system and a control output vector of a reference model;
a bi-level meta-learning optimization module 804 configured to calculate a meta-parameter by meta-learning according to the ship trajectory model set and the adaptive law; and
a control execution module 805 configured to perform adaptive motion control of the underactuated ship according to the meta-parameter.

The contents of the embodiments of the method of the present disclosure are applicable to the present apparatus embodiment. Functions implemented in the present device embodiment are the same as those in the above method embodiments, and the present apparatus embodiment can achieve the same beneficial effects as those achieved in the above method embodiments.

As shown in FIG. 6, an embodiment of the present disclosure further provides a computer device, including: at least one processor 901; and at least one memory 902, configured to store at least one program. The at least one program, when executed by the at least one processor, causes the at least processor to implement the method of FIG. 1.

The contents of the embodiments of the method of the present disclosure are applicable to the present apparatus embodiment. Functions implemented in the present device embodiment are the same as those in the above method embodiments, and the present apparatus embodiment can achieve the same beneficial effects as those achieved in the above method embodiments.

Although some embodiments of the present disclosure are described above with reference to the accompanying drawings, these embodiments are not intended to limit the protection scope of the embodiments of the present disclosure. Any modifications, equivalent replacements and improvements made by those having ordinary skills in the art without departing from the scope and essence of the embodiments of the present disclosure shall fall within the protection scope of the embodiments of the present disclosure.

What is claimed is:

1. A method of meta-learning-based adaptive motion control for an underactuated ship, comprising steps of:
acquiring ship trajectory data comprising a set of actual ship states and an initial control input;
constructing a data-driven reference ship model set according to the ship trajectory data;
determining an adaptive control law according to the set of actual ship states and a set of control states of the data-driven reference ship model set;
performing adaptive control of the ship along different trajectories by employing different data-driven reference ship models and parameters of the adaptive control law, and collecting corresponding trajectory data;
calculating a meta-parameter associated with the data-driven reference ship model set and the adaptive control law; and
performing meta-learning to optimize the meta-parameter.

2. The method of claim 1, wherein constructing a data-driven reference ship model set according to the ship trajectory data comprises:
acquiring ship trajectory data comprising a plurality of ship states and corresponding control inputs under different environmental conditions;
performing preprocessing on the acquired trajectory data to remove noise, normalizing features, and establishing consistent temporal alignment among the data samples;
fitting, under reasonable disturbance assumptions, a parameterized dynamic model for each trajectory using a neural network configured to capture nonlinear relationships between the ship states and control inputs;
training model parameters of each dynamic model via a gradient descent-based optimization method to obtain a plurality of trained dynamic models corresponding to different trajectories or environmental conditions; and
aggregating the plurality of trained dynamic models to form a model ensemble representing the dynamic characteristics of the ship across multiple environmental conditions.

3. The method of claim 2, wherein the neural network is constructed via steps of:
constructing an input layer configured to receive a current moment state of the ship and the initial control input;
constructing two hidden layers after the input layer, wherein the hidden layer is configured to calculate a next moment state of the ship using a preset nonlinear activation function according to the current moment state and the initial control input; and
constructing an output layer after the two hidden layers.

4. The method of claim 1, wherein determining an adaptive control law according to the set of actual ship states and a set of control states of the data-driven reference ship model set comprises steps of:
constructing state space equations for the controller system by linearizing the reference models;
receiving a state vector of the controlled system and computing a state vector of a reference model based on their respective control inputs;
calculating a system state error between the actual state vector of the controller system and the state vector of the reference model;
constructing a Lyapunov function according to the state matrix of the reference model and a positive definite matrix;
constructing a real-valued function according to the state error between the reference output from the reference model and the actual output of the controller system, the Lyapunov function value;
differentiating the real-valued function to obtain a derivative equation of the real-valued function;
performing a negative definite transformation on the derivative equation of the real-valued function as a whole to obtain a system of negative definite equations; and
determining the adaptive control law according to the system of negative definite equations and a gain matrix; and
applying the control law to the controlled system.

5. The method of claim 1, wherein calculating a meta-parameter associated with the data-driven reference ship model set and the adaptive control law comprises steps of:
determining controller parameters based on an adaptive control law and a current state error of a controlled system;
selecting a set of trajectory tracking tasks; and
in each trajectory task:
generating a control input according to the current state of the controller system and a reference model output, and a current disturbance condition;
performing real-time adjustment of the parameters of the adaptive control law in each trajectory tracking task based on the state error between the controller system and the reference model;
constraining and optimizing the parameter adjustment process by using a meta-parameter obtained through training across multiple control tasks within a meta-learning framework;
adjusting the parameters of adaptive control law according to the meta-parameter such that the controller achieves rapid adaptation to varying disturbance conditions; and
updating the meta-parameter according to an optimization process defined over multiple control tasks to continuously improve overall control adaptability and stability.

6. A computer device, comprising:
at least one processor; and
at least one memory configured to store at least one program,
wherein the at least one program, when executed by the at least one processor, causes the at least processor to perform a meta-learning-based adaptive motion control method comprising:
acquiring ship trajectory data comprising a set of actual ship states and an initial control input;
constructing a data-driven reference ship model set according to the ship trajectory data;
determining an adaptive control law according to the set of actual ship states and a set of control states of the data-driven reference model set;
performing adaptive control of the ship along different trajectories by employing different reference models and parameters of the adaptive control law, and collecting corresponding trajectory data;
calculating a meta-parameter associated with the data-driven reference ship model set and the adaptive control law; and
performing meta-learning to optimize the meta-parameter.

7. The computer device of claim 6, wherein constructing a data-driven reference ship model set according to the ship trajectory data comprises:
acquiring ship trajectory data comprising a plurality of ship states and corresponding control inputs under different environmental conditions;
performing preprocessing on the acquired trajectory data to remove noise, normalizing features, and establishing consistent temporal alignment among the data samples;
fitting, under reasonable disturbance assumptions, a parameterized dynamic model for each trajectory using a neural network configured to capture nonlinear relationships between the ship states and control inputs;
training model parameters of each dynamic model via a gradient descent-based optimization method to obtain a plurality of trained dynamic models corresponding to different trajectories or environmental conditions; and
aggregating the plurality of trained dynamic models to form a model ensemble representing dynamic characteristics of the ship across multiple environmental conditions.

8. The computer device of claim 7, wherein the neural network is constructed via a process comprising steps of:
constructing an input layer configured to receive a current moment state of the ship and the initial control input;
constructing two hidden layers after the input layer, wherein the hidden layer is configured to calculate a next moment state of the ship using a preset nonlinear activation function according to the current moment state and the initial control input; and
constructing an output layer after the two hidden layers.

9. The computer device of claim 6, wherein determining an adaptive control law according to the set of actual ship states and a set of control states of the data-driven reference ship model set comprises steps of:
constructing state space equations for the controller system by linearizing the reference models;
receiving a state vector of the controlled system and computing a state vector of a reference model based on their respective control inputs;
calculating a system state error between the actual state vector of the controller system and the state vector of the reference model;
constructing a Lyapunov function according to the state matrix of the reference model and a positive definite matrix;
constructing a real-valued function according to the state error between the reference output from the reference model and the actual output of the controller system, the Lyapunov function value;
differentiating the real-valued function to obtain a derivative equation of the real-valued function;
performing a negative definite transformation on the derivative equation of the real-valued function as a whole to obtain a system of negative definite equations; and
determining the adaptive control law according to the system of negative definite equations and a gain matrix; and
applying the control law to the controlled system.

10. The computer device of claim 6, wherein calculating a meta-parameter associated with the data-driven reference ship model set and the adaptive control law comprises steps of:
determining controller parameters based on an adaptive control law and a current state error of a controlled system;
selecting a set of trajectory tracking tasks; and
in each trajectory task;
generating a control input according to the current state of the controller system and a reference model output, and a current disturbance condition;
performing real-time adjustment of the parameters of the adaptive control law in each trajectory tracking task based on the state error between the controller system and the reference model;
constraining and optimizing the parameter adjustment process by using a meta-parameter obtained through training across multiple control tasks within a meta-learning framework;
adjusting the parameters of adaptive control law according to the meta-parameter such that the controller achieves rapid adaptation to varying disturbance conditions; and
updating the meta-parameter according to an optimization process defined over multiple control tasks to continuously improve overall control adaptability and stability.

11. A non-transitory computer-readable storage medium storing a computer-executable instruction which, when executed by a processor, causes the processor to perform a meta-learning-based adaptive motion control method comprising steps of:
acquiring ship trajectory data comprising a set of actual ship states and an initial control input;
constructing a data-driven reference ship model set according to the ship trajectory data;
determining an adaptive control law according to the set of actual ship states and a set of output states of the data-driven reference ship model set;
performing adaptive control of the ship along different trajectories by employing different data-driven reference ship models and parameters of the adaptive control law, and collecting corresponding trajectory data;
calculating a meta-parameter associated with the data-driven reference ship model set and the adaptive control law; and
performing meta-learning to optimize the meta-parameter.

12. The non-transitory computer-readable storage medium of claim 11, wherein constructing a data-driven reference ship model set according to the ship trajectory data comprises steps of:
acquiring ship trajectory data comprising a plurality of ship states and corresponding control inputs under different environmental conditions;
performing preprocessing on the acquired trajectory data to remove noise, normalizing features, and establishing consistent temporal alignment among the data samples;
fitting, under reasonable disturbance assumptions, a parameterized dynamic model for each trajectory using a neural network configured to capture nonlinear relationships between the ship states and control inputs;
training model parameters of each dynamic model via a gradient descent-based optimization method to obtain a plurality of trained dynamic models corresponding to different trajectories or environmental conditions; and
aggregating the plurality of trained dynamic models to form a model ensemble representing dynamic characteristics of the ship across multiple environmental conditions.

13. The non-transitory computer-readable storage medium of claim 11, wherein a construction process of the preset neural network comprises steps of:
constructing an input layer configured to receive a current moment state of the ship and the initial control input;
constructing two hidden layers after the input layer, wherein the hidden layer is configured to calculate a next moment state of the ship using a preset nonlinear activation function according to the current moment state and the initial control input; and
constructing an output layer after the two hidden layers.

14. The non-transitory computer-readable storage medium of claim 11, wherein determining an adaptive control law according to the set of actual ship states and a set of control states of the data-driven reference ship model set comprises steps of:
constructing state space equations for the controller system by linearizing the reference models;
receiving a state vector of the controlled system and computing a state vector of a reference model based on their respective control inputs;
calculating a system state error between the actual state vector of the controller system and the state vector of the reference model;
constructing a Lyapunov function according to the state matrix of the reference model and a positive definite matrix;
constructing a real-valued function according to the state error between the reference output from the reference model and the actual output of the controller system, the Lyapunov function value;
differentiating the real-valued function to obtain a derivative equation of the real-valued function;
performing a negative definite transformation on the derivative equation of the real-valued function as a whole to obtain a system of negative definite equations; and
determining the adaptive control law according to the system of negative definite equations and a gain matrix; and
applying the control law to the controlled system.

15. The non-transitory computer-readable storage medium of claim 11, wherein calculating a meta-parameter associated with the data-driven reference ship model set and the adaptive control law comprises steps of:
determining controller parameters based on an adaptive control law and a current state error of a controlled system;
selecting a set of trajectory tracking tasks; and
in each trajectory task:
generating a control input according to the current state of the controller system and a reference model output, and a current disturbance condition;
performing real-time adjustment of the parameters of the adaptive control law in each trajectory tracking task based on the state error between the controller system and the reference model;
constraining and optimizing the parameter adjustment process by using a meta-parameter obtained through training across multiple control tasks within a meta-learning framework;
adjusting the parameters of adaptive control law according to the meta-parameter such that the controller achieves rapid adaptation to varying disturbance conditions; and
updating the meta-parameter according to an optimization process defined over multiple control tasks to continuously improve overall control adaptability and stability.
